(19) United States
(12) Patent Application Publication
(10) Pub. No.: US 2005/0156130 A1
(43) Pub. Date: Jul. 21, 2005

(54) Shunt valve for use in winterizing a pool

(75) Inventor: Dimce Vasilev, Wheaton, IL (US)

Correspondence Address: Dimce Vasilev, Unit K, 415 W. Belden, Addison, IL, 60101, US

(73) Assignee: Gigit Incorporated

(21) Appl. No.: 11/078,954

(22) Filed: Mar. 11, 2005

Related U.S. Application Data
(63) Continuation-in-part of application No. 10/366,136, filed on Feb. 13, 2003, now Pat. No. 6,877,524.
(63) Continuation-in-part of application No. 10/814,519, filed on Mar. 31, 2004.

(51) Int. Cl. F16L 29/00; F16K 51/00; G21C 19/00

(52) U.S. Cl. 251/148

(57) ABSTRACT

A shunt valve for use in winterizing a pool is interposed between two segments of a pool pipe and has an inlet for air and a rotatable diverter for blocking the flow of air to one segment of the pool pipe and directing the flow of air into a second segment of the pool pipe.

### RELATED APPLICATIONS

The present application is a Continuation-In-Part of and claims priority to U.S. patent application Ser. No. 10/814,519, filed Mar. 31, 2004, which is a Continuation-In-Part of U.S. patent application Ser. No. 10/366,136 (recently allowed, issue fee paid), filed Feb. 13, 2003, the entire contents of both hereby incorporated herein by reference.

### FIELD OF THE INVENTION

This invention concerns conditioning a pool for the cold weather season, and more particularly conditioning the pool pipes for the cold season and preparing the pool pipes for the warm season.

### BACKGROUND OF THE INVENTION

In climates that have freezing seasonal temperatures, the maintenance of swimming pools includes a winterizing process. As part of the winterizing process, the system of conduits and pipes that support water flow into and out of the pool are drained because water left in those pipes and conduits will likely freeze and expand as the temperature drops below freezing, damaging the pipes and fittings. For in-ground pools, the winterizing process typically involves the steps of draining water from all pipes situated above the frost line (typically to three feet below ground level), partially filling the pipes with anti-freeze to prevent the freezing of residual water, closing exposed orifices in the pool side wall to prevent ingress of water, debris, rain or snow into the pipes and conduits, and removing or protecting outside mechanical equipment. It is necessary to prepare swimming pools for such temperatures in order to avoid extensive damage, particularly to those pipes and conduits that are buried in the ground but above the frost line.

In most in-ground pool systems, the return and drain pipes are fitted through each respective aperture in the pool wall. The pool apertures are typically situated well below the normal water line, perhaps by as much as thirty to fifty centimeters. In prior art winterization procedures, one first reduced the water level to below the aperture levels so that the water remaining in the pipes above the frost line can be drained. Such a procedure requires extensive draining of pool water, which can take up to eight hours. Draining to that level can involve the removal of several thousand liters of water from a typical residential swimming pool, perhaps as much as twenty-five thousand liters. The drained water usually is wasted. After the pool is drained the pipe ends are capped so that water and moisture cannot enter the pipes. As a cautionary measure, antifreeze has been and continues to be (in most cases) added before the pipe ends are capped to prevent freezing and expansion of residual water. The winterization process further includes refilling of the pool to about the normal water level to protect the pool structure from collapsing as the surrounding ground freezes and expands.

Referring to the drawings, a conventional swimming pool arrangement is illustrated by FIG. 1; the arrangement comprises generally the pool having a peripheral rectangular wall as shown at 11 and a circulation and filtration system, the several parts of which are encompassed within the area of the broken line 10, is situated contiguous to one end of the pool 11. Typically, the plumbing accessories include at least a main drain 12 which draws water and sediment from the bottom of the swimming pool and a skimmer 13 through which water to be filtered and re-circulated is withdrawn and debris is removed. In the circulation process, water withdrawn from the pool through the main drain and from the skimmer is filtered and optionally chemically treated and returned to the swimming pool through returns such as shown at 14 and 15.

A pump 24 withdraws water from the swimming pool, the water is filtered at 25, and through use of appropriate valves, such as 21 and 23, is reintroduced into the swimming pool at return points such as those illustrated at 14 and 15. Suction piping, some of which is illustrated at 19 and 20, and discharge piping, as shown at 16, 17 and 18, are utilized to move the water between the pump and the pool. The pool has a plurality of apertures to accommodate return piping 14 and 15 and main drain piping 20. Likewise, skimmer 13 has an aperture to accommodate suction piping 19. Portions of the piping referred to at 14, 15, 16, 17, 18, 19, and 20 are above the frost line and all water must be expunged therefrom to prevent freezing and damage to the piping system. Antifreeze may then be introduced into the pool pipes to prevent residual water from freezing.

It is an object of the present invention to clear the pipes of pool water in preparation for the cold weather season and provide a means for adding an antifreeze solution thereto.

### SUMMARY OF THE INVENTION

A shunt valve for use in purging water from at least one pipe. The shunt valve comprises a T-connector. A cap is secured to the base of the T-connector and pool water is allowed to flow through the pool pipes. The cap is removed and replaced with an air flow diverter and an air valve. The air flow diverter blocks the flow of air and/or water through a first leg of the one-way air-water valve and diverts the flow of air toward the other, second leg. The air flow diverter may be rotated one-hundred and eighty degrees to direct air toward the first leg and block the flow of air and/or water through the second leg. The shunt valve may be used in conjunction with a valve assembly to winterize a pool.

The valve assembly has a housing that is threaded or otherwise configured at one end so that it can be secured at a pool aperture to an inlet or outlet pipe-end. Internally, the assembly has a flow aperture adjacent a flow conduit so that water and air can flow through the valve. A ring circumscribes the flow aperture and provides a flow occlusion surface defining a gate plate. In a first, closed state, a valve gate having at least one gate-flow aperture is in contact with the flow occlusion surface. In this position, the flow occlusion surface obstructs liquid flow, preventing liquid from flowing through the gate-flow aperture(s). In a second, open state, the valve gate is forced away from the flow occlusion surface under the pressure of air or liquid flowing into the valve, through the flow conduit and the flow aperture. A containment lip fixed to the valve housing internally circumscribes the outlet of the valve, prohibiting further movement of the valve gate in the direction of flow. When the valve is open, the boundaries of a gate channel are defined by the location of the flow aperture and the gate-flow aperture(s). The valve thus allows fluid to flow in only one direction, that is out of the pool pipes in the direction of the pool.

### BRIEF DESCRIPTION OF THE DRAWINGS

In describing the present invention, reference is made to accompanying drawings wherein:

FIG. 1 is a schematic diagram illustrating by plan view a swimming pool equipped with a typical water circulating and filtration system.

FIG. 2 is an exploded perspective view showing a first exemplary embodiment of the valve assembly component of the present invention.

FIG. 3 is an exploded perspective view that shows a second exemplary embodiment of the valve assembly component of the present invention along with a valve cap and a valve socket.

FIG. 4 is an exploded cross-sectional view taken along lines 5-5 of FIG. 3.

FIG. 5 is a cross-sectional view taken along lines 5-5 of FIG. 3 showing the valve gate in the valve closed position and showing in phantom the valve gate in the open position.

FIG. 6 is a end view of the valve assembly component of the second embodiment of the present invention showing in phantom components of a socket as applied to the valve.

FIG. 7 is a perspective view showing one embodiment of the shunt valve of the present invention partially secured to a T-connector, the porthole being partially viewable through the T-connector opening.

FIG. 8 is a perspective view of the T-connector of FIG. 7 for connection in line with a section of the pool piping of FIG. 1.

FIG. 9 is a perspective view showing a preferred air flow director for one embodiment of the shunt valve of the present inveniton.

FIG. 10 is a perspective view of the air valve of FIG. 7.

FIG. 11 is a cross sectional view of the air valve of FIG. 10.

### DETAILED DESCRIPTION OF THE PREFERRED EMBODIMENT

Valve Assembly

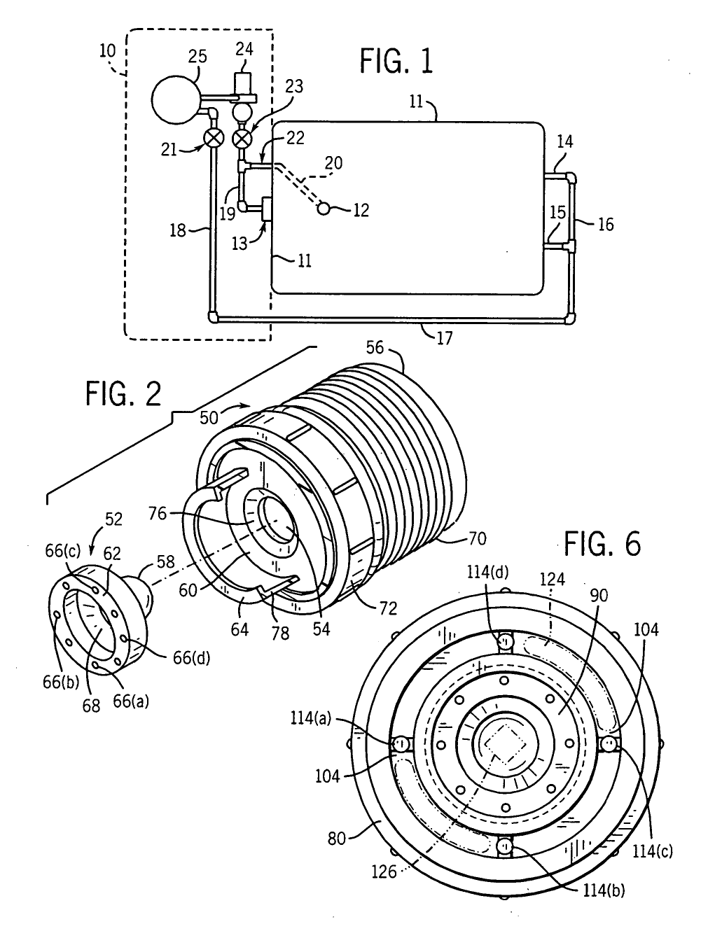

The valve assembly is configured for fastening at a pool-wall aperture to a pipe end (inlet or outlet). In pool systems having a main drain, a valve assembly may be fastened thereto as well. In the preferred embodiment, the valve adaptor is configured at one end for attachment to the valve assembly and at the other end for attachment to a hose, or other accessory. As discussed in more detail below, the valve assembly opens to allow water, antifreeze, or mixture thereof to be pumped through a pipe/conduit and into the pool if the adaptor component of the invention is detached from the valve assembly. If the adaptor and valve components are coupled together, water/antifreeze will flow through the open valve and adaptor and, preferably, into a hose threaded to the adaptor. Conversely, the valve closes to prevent fluid from flowing back into the pipe/conduit. The valve assembly of the present invention thereby obviates the need to drain the pool to a water level below the pool-wall apertures (in FIG. 1, associated with the returns 14 and 15, skimmer 13, and main drain 12) for emptying the pipes and conduits of all water when the pool is conditioned for winter conditions. For the reopening procedure in the warm weather season, the valve assembly provides that fluid in the pool pipes may be pumped into a hose and salvaged. The valve is then removed from the pool aperture and pool water enters and fills the pool pipes.

Referring to FIG. 2, a first embodiment of the valve assembly component of the present invention includes a main valve housing 50 and a valve gate 52. The valve housing 50 includes a flow aperture 54 adjacent a flow conduit or cavity, not visible in FIG. 2. The flow conduit continues through the opposite end 56 of the housing. The valve housing has threads 70 for securing the valve assembly at a pool aperture to the end of a pipe/conduit. A rim 72 is preferably molded to or part of the valve housing so the valve assembly can be tightened against the pool wall. A gasket is preferably utilized to form an airtight seal between the rim 72 and the pool wall/surface.

The valve gate 52 preferably includes a conical plug 58 configured to rest against a housing seat 76 when the valve is closed, as discussed below. Preferably, the conical plug 58 is hollow, the outer shell configured to fit within flow aperture 54 allowing the plug to glide along the housing seat 76. The valve gate 52 includes a ringed control plate 62 fixed to the conical plug 58. Preferably, the dimension (diameter) of the area 68 within the ring 62 is uniform with that of the adjoining hollow portion of conical plug 58. The control plate 62 further includes a plurality of small holes or gate-flow apertures 66(a), 66(b), 66(c), and 66(d) extending therethrough and circumferentially disposed around the plate.

In one embodiment, the valve is assembled by pressing the control plate 62 onto and past a plastic semi-flexible containment lip 64 and into a gate channel defined by the containment lip 64, a valve housing gate channel wall 78, and a housing gate plate 60. The gate channel confines movement of the valve gate between “valve open” and a “valve closed” positions. As noted, the main valve housing 50 has a circular containment lip 64 extending radially inward from a main valve housing gate channel wall 78 (partially shown). The containment lip catches the control plate 62 by a portion of its outer perimeter when the valve gate 52 moves, under the force of water or air flowing out of the pool pipe, away from the housing gate plate 60 to a “valve open” position. The containment lip 64 is far enough away from the housing gate plate 60 to allow the valve gate to move a limited distance (preferably one-half centimeter) from the housing gate plate 60, thereby allowing water or air to flow through a flow channel formed between the housing gate plate 60 and the control plate 62. Water or air may thus flow through the flow aperture 54, through the gate-flow apertures 66(a), 66(b), 66(c), and 66(d), and out of the valve.

In application, the valve assembly is tightened into an aperture of the pool leading to a drain or return. The pump and pump system valves are adjusted so that air is pumped through the corresponding pipe. Pressurized air in the pipe will push the water toward the orifice and will force the valve gate 52 away from the housing gate plate, allowing water to flow through and out of the valve.

After all the water has exited the pipe, the pump is turned off. The pool water exerts sufficient force against the control plate 62 and the interior of the conical plug 58 to move the valve gate 52 to the closed position. In the closed position the control plate 62 is in contact with and pressed against the surface (occlusion surface) of the housing gate plate 60, closing off the gate-flow apertures 66(a), 66(b), 66(c), and 66(d), thus preventing pool water from flowing into the valve and back into the pipe. In an alternate embodiment, the water in the pool forces the valve gate 52 against the housing gate plate 60 and prevents water from flowing through the flow aperture 54, closing the valve. In such an embodiment, the control plate 62 includes slits spatially situated at its outer circumference (thus resembling a toothed wheel) so that pipe water may exit the valve therethrouh when the valve gate is in the open position. In another embodiment, the valve gate has flow apertures and slits, and both the gate-flow aperture and the flow aperture are closed off when the valve gate contacts the housing gate plate 60.

Depending upon the pumping capacity of pump 24, each of the return conduits 14 and 15, the skimmer conduit 19, and main drain conduit 22 may be emptied individually/sequentially, in pairs, or all at the same time. In any case, it is preferred that one valve assembly be provided for each conduit.

Preferably, both the main valve housing 50 and the valve gate 52 are molded from forty percent calcium-filled polypropylene.

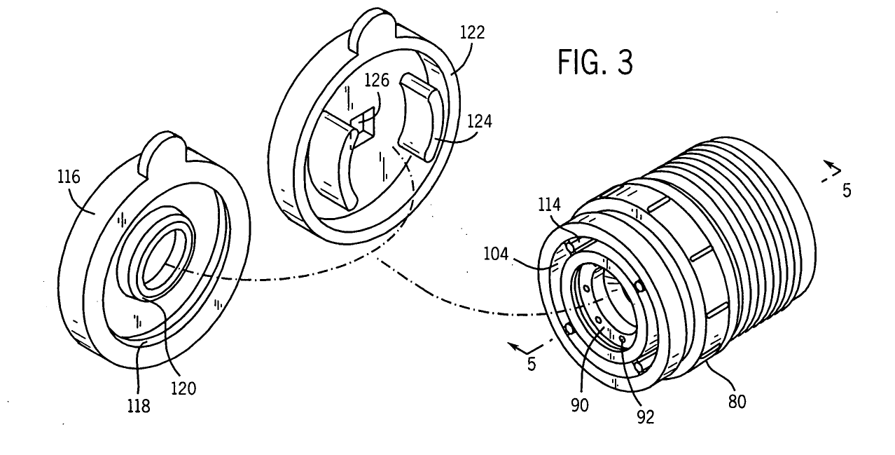

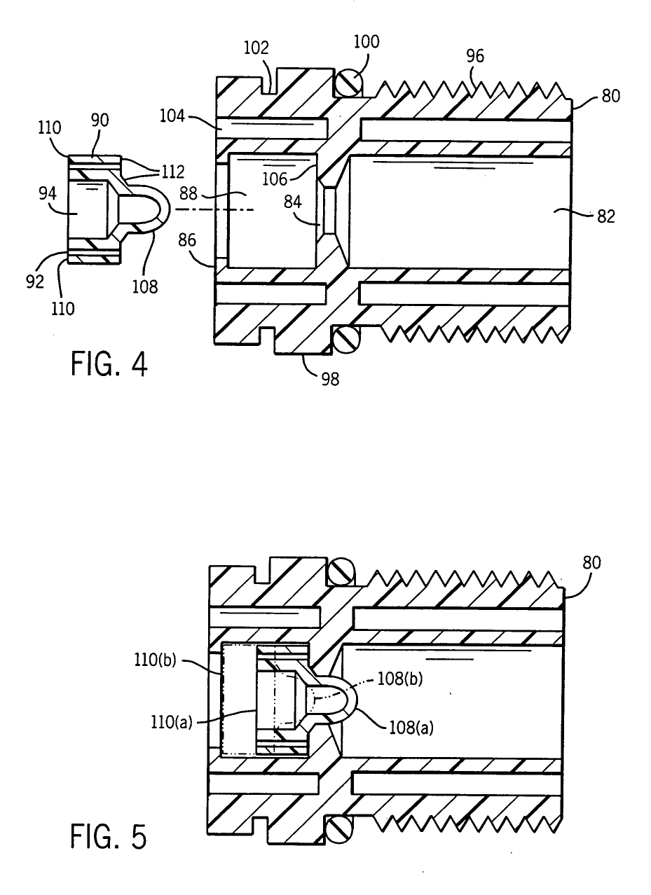

A second embodiment of the valve assembly component of the present invention is shown in FIGS. 3-6. The valve assembly of this embodiment has a valve housing 80 and a valve gate 90. As shown in the cross-sectional view of FIG. 4, the valve housing 80 has a flow cavity 82 for directing water or air flow from a pipe or conduit to a flow aperture 84. A containment lip 86 extends radially inward at one end of the valve housing. A gate channel 88 is defined on one side by the containment lip 86 and on the opposite side by a gate plate 106. A valve gate 90, having a plurality of gate-flow apertures 92 (see FIG. 3), is configured for reciprocating movement within gate channel 88. Fluid or air pumped into the flow cavity 82 exerts force against a conical structure 108 of the valve gate 90. This force moves the valve gate to an open position wherein the outer perimeter 110 of the valve gate is pressed against the containment lip 86 (shown in phantom as 110(b) in FIG. 5) and the conical portion of the valve gate, shown as 108(b), is removed from the flow aperture. In this position a flow channel exists between the gate plate 106 and the opposing surface 112 of the valve gate. In the preferred embodiment the flow channel is four centimeters wide. The plurality of gate-flow apertures 92 allow fluid or air to flow out of the valve assembly component. In the preferred embodiment, there are eight gate-flow apertures, each most preferably being circular in shape, having a diameter of seventy-eight one-thousands of an inch, and being disposed circumferentially about the valve plate.

With reference to the winterization procedure discussed above, antifreeze may be introduced to the pool pipes at or near the pool pump by a compressor connected (temporarily or fixed) to the system. The compressor is turned on until a predetermined amount of antifreeze is input into the pipe(s) or until antifreeze just begins to exit the valve assembly.

When the pool pump is turned-off and air or antifreeze is in the pool pipe, the water in the pool exerts force against the inner surface 94 of the conical plug and also against the surface 110 of the valve gate 90 adjacent the valve outlet, moving the valve gate to a closed position (shown in FIG. 5). In this embodiment, flow aperture 84 is shaped to receive conical structure 108(a) and guide the valve gate as it moves between the open and the closed positions. In the closed position the opposing surface 112 of the valve gate is juxtaposed to the gate plate 106, closing off the gate-flow apertures 92, preventing pool water from flowing back into the flow cavity 82.

The valve housing is configured so that it may be secured at a pool aperture to a pipe end. Typically, the pipe end is internally threaded. Thus, the valve housing is preferably provided with a threaded outer surface 96 having a diameter of one and seven-hundred and fifty one-thousands inches, and a rim 98 for securing the valve assembly to a pool orifice. A one-eight inch diameter O-ring 100 is preferably utilized to ensure an air-tight seal between the valve assembly and the pipe end, as well as between the outer diameter of the valve assembly and inner diameter of the pool wall or pipe mounting plate. It is preferable to coat threaded surface 96 with several layers of a suitable tape, such as that sold under the trademark TEFLON®, to create a seal between the valve housing and the pipe end, and also to prevent the housing threads from burning (due to friction heat) to the pipe threads as the housing is screwed on.

Alternatively, if the pool pipe end is not internally threaded but rather has another mating mechanism, the pool valve housing may be configured/molded with a reciprocating mechanism, or alternatively, a reciprocating mechanism may be threaded to the valve housing discussed above.

To facilitate molding of the valve housing, in one embodiment components of the valve housing are tapered in accordance with the following: the diameter of the threaded surface of the housing is tapered down six one-hundredths of an inch from the O-ring to the end of the housing; the diameter of the flow cavity is increased one hundred and twenty five one-thousandths of an inch from the flow aperture 84 to the end of the housing; the diameter of the gate channel 88 is increased one one-hundredth of an inch from the flow aperture to the containment lip; the outer diameter of the housing is tapered three one-hundredths of an inch from groove 102 to the end of the valve (the end associated with the containment lip); housing surfaces defining other open spaces (such as shown at 104) in the valve housing may also be slightly tapered to facilitate the molding process.

Referring again to FIG. 3, optional but preferred winterization components for use with the valve assembly component are shown and include a rubber cap 116. The rubber is provided for placement over the valve assembly after all the water is pumped out of a pipe and the valve closes. The rubber cap 116 functions to further ensure that water/moisture cannot enter the valve assembly. In the present embodiment, the valve housing has a groove 102 (see FIG. 4) configured for receiving a radially inward extending lip 118 of the rubber cap for securing the cap to the valve housing. Preferably, the rubber cap also has a raised surface 120 dimensioned to cover the outer surface 110 (see FIG. 4) and/or flow apertures 92 of the valve gate 90 when the valve housing receives the cap. The raised surface further serves to hold the valve gate against the gate plate. With the valve assembly in a closed state and the pipe having been emptied of all water the cap is preferably placed on the valve for the duration of the winter. To facilitate placement of the cap 116 over the valve assembly, marine grease may be rubbed along the lip 118 and over the raised surface 120.

Referring once again to FIG. 3, a valve assembly socket 122 is shown as an optional component. The valve assembly socket 122 is used to loosen the valve assembly from the pipe. The socket has a pair of arcuate dogs 124 configured to fit into an open space 104 of the valve housing 80 (shown in FIG. 6) having a catch 114 on both sides thereof. A preferably square-shaped aperture 126 (also shown in phantom in FIG. 6) receives a wrench, enabling one to generate sufficient torque to remove the valve assembly.

Preferably, the valve assembly of the second embodiment and the socket are molded from forty percent calcium-filled polypropylene.

Shunt Valve

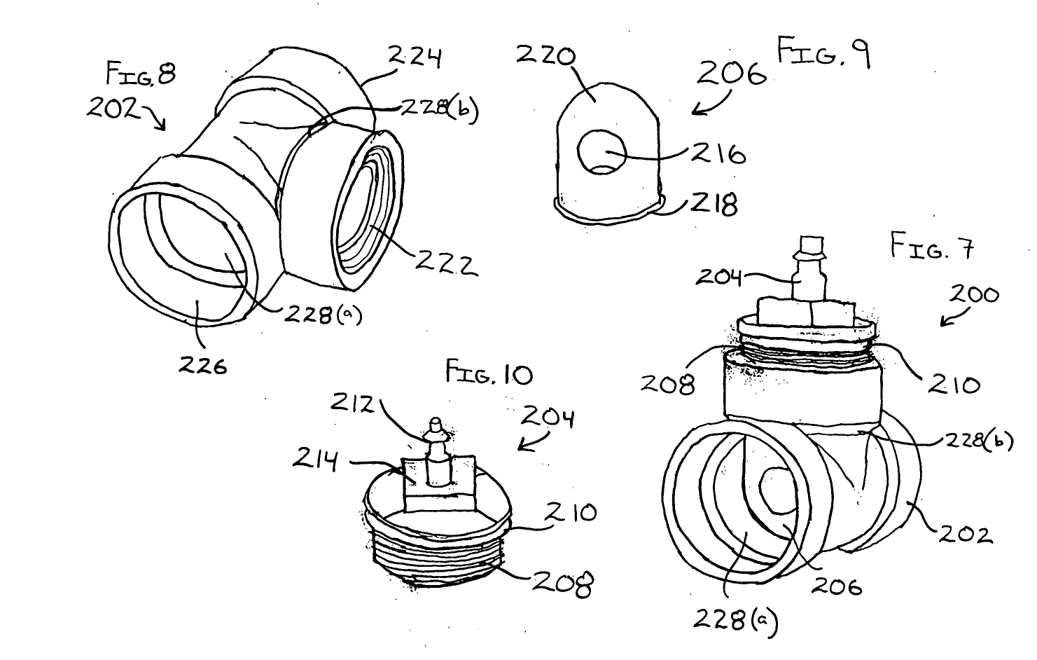

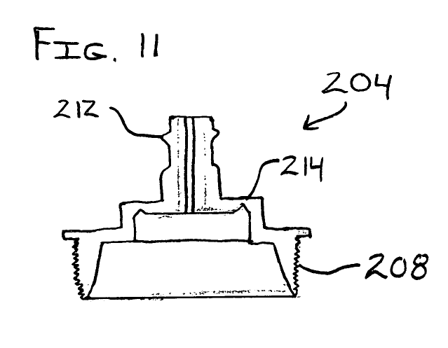

Referring to FIGS. 7-11, a shunt valve in accordance with the invention comprises an air flow diverter 206 and an air valve 204. The shunt valve is secured to the base 222 of the T-connector 202 so that pressurized air may be introduced into a pool pipe for purging pool water from the pipe. The shunt valve comprises an air flow diverter 204 having a dome-shaped body configured to fit snugly against the interior walls of the T-connector 228(a). Preferably, the air flow diverter 206 has a dome 220 having a radius that is equal to the radius of the interior of the T-connector. A porthole 216 directs air input into the air valve in one direction in the T-connector and pool pipe. Referring to FIG. 7, the air flow diverter 206 is oriented to direct air out of the T-connector toward the viewer. The air flow diverter 206 is preferably removable. It may be rotated one-hundred eighty degrees to direct air in the opposite direction. A rim 218 has an outer radius slightly greater than the radius of the dome 220 and approximately equal to that of an inset 228(b) at the entrance of the T-connector. Preferably, if the air diverter is inserted in the T-connector, the rim abuts the inset.

The air valve 204 has outer threads 208 to match the threads 222 at the inside of the base entrance to the T-connector 202. A gasket 210 provides an air-tight seal between the air valve 204 and the T-connector opening 222. A bolt head 214 is fixed to or formed with the top of the air valve so that a wrench may be used to tighten and loosen the air valve 204 to the T-connector 202. An air hose nipple 212 facilitates attachment to an air hose and has an aperture traversing the air valve so that air may be pumped into the pool piping.

In the preferred embodiment, the shunt valve is sized to fit standardized dimensions of PVC piping used in most pool systems (two inch diameter). However, the shunt valve may be dimensioned to fit any sized piping T-connector, and may be constructed out of any suitable material (PVC preferred).

It is to be understood that the above-described embodiments are merely illustrative of the principles of the invention and that many variations may be devised by those skilled in the art without departing from the scope of the invention. It is, therefore, intended that such and other variations be included within the scope of the following claims.

1. A shunt valve for attachment to a T-connector having an interior surface, for use in purging pool water from a pool pipe, comprising:
an air flow diverter having a porthole and an outer surface dimensioned to be in contact with the T-connector interior surface when inserted in the base of the T-connector; and
an air valve having a threaded surface for connection to the base of the T-connector and in communication with the air flow diverter for receiving air from an air hose and outputting the air through the porthole.

2. An assembly for introducing air into a continuous segment of pool piping, comprising:
a T-connector having a base aperture;
an air flow diverter within the base aperture; and
an air valve attached to the base aperture;
wherein the air flow diverter directs air out of a first leg of the T-connector and prevents air flow to the second leg of the T-connector.

3. The assembly of claim 2 wherein the air flow diverter is rotatable to direct air out of the second leg of the T-connector and prevents air flow to the first leg of the T-connector.

4. A shunt valve comprising:
an air valve threaded for attachment to a threaded opening in a pool pipe;
an air flow diverter for removable insertion into the threaded opening in the pool pipe and having a closed surface having a port hole for directing the flow of air received from the air valve in the direction of the port hole.
